(19) United States
(12) Patent Application Publication
(10) Pub. No.: US 2008/0052455 A1
(43) Pub. Date: Feb. 28, 2008

(54) Method and System for Mapping Disk Drives in a Shared Disk Cluster

(75) Inventors: Mahmoud B. Ahmadian, Pflugerville, TX (US); Anthony Fernandez, Cedar Park, TX (US); Ronald Robert Pepper, Hutto, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 11/467,703

(22) Filed: Aug. 28, 2006

(51) Int. Cl. G06F 12/00

(52) U.S. Cl. 711/112; 711/147

(57) ABSTRACT

An information handling system may include a cluster. The cluster may comprise at least a first node and a second node. The first node may include a first shared disk mapping driver and a second node may include a second shared disk mapping driver. The first node and the second node may be in communication with one or more shared storage disks and the shared disk mapping driver may be configured to communicate with the second shared disk mapping driver for assigning a common device name to the shared storage disks.

### TECHNICAL FIELD

The present disclosure relates generally to storage devices in information handling systems and, more particularly, to a system and method for mapping disk drives in a shared disk cluster of an information handling system.

### BACKGROUND

As the value and use of information continues to increase, individuals and businesses seek additional ways to process and store information. One option available to users are information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, RAID disk system and telecommunications switch.

Some information handling systems may include multiple components grouped together and arranged as clusters. For instance, Oracle Real Application Clusters (RAC) enable multiple clustered devices to share external storage resources such as storage disks. In these situations, it is desirable for components within the cluster to have the same view of the shared storage resources. For example, a disk device having a given identifier used by a first node should correspond to the same identifier that is used by a second node.

For example, an existing multi-node Oracle RAC may be attached to a shared storage device. However, depending on the arrangement of Host Bus Adapters (HBAs) arid/or the platform type, the disks in the external storage may appear to be in a different order to different cluster nodes. In these situations, the same disk device may appear to different nodes as different disk devices (or will appear with different names or identifiers). For example, disk X from the external shared storage may appear as “\dev\sdb1” on a first node and as “dev\sde1” on a second node. This creates a number of difficulties when the first node and the second node are interacting with the shared disk devices.

One method of resolving this problem is by manually mapping the disk devices to identical mount points. However, this solution is both tedious and error prone as the number of disk devices may range in the hundreds and even more tedious with storage area network (SAN) topologies and multi-pathing to storage and is therefore impractical.

### SUMMARY

Therefore what is needed is a system and method for ensuring that storage devices shared by multiple nodes in a cluster have common identifiers.

According to teachings of this disclosure, an information handling system may include a cluster that may comprise at least a first node and a second node. The first node may include a first shared disk mapping driver and the second node may include a second shared disk mapping driver. The first node and the second node are in communication with one or more shared storage disks and the shared disk mapping driver is configured to communicate with the second shared disk mapping driver to assign a common device name to the shared storage disks.

A driver for mapping shared disks in a cluster may include an arbitration module and a device name assignment module. The arbitration module may be configured to determine a master driver among two or more drivers. The device name assignment module may be configured to assign a common device name to an associated shared storage disk that is to be used by two or more nodes that share the storage disk.

A method for mapping shared storage devices in a cluster may include providing a shared disk mapping driver with each of two or more nodes in a cluster. The method may further include determining a master shared disk mapping driver and one or more non-master shared disk mapping drivers. The method may also include using the master driver to assign a common device name to a shared storage disk and communicating the common device name to the non-master shared device mapping drivers. The non-master shared disk mapping drivers may then assign the common device name for identifying the selected shared storage disks.

According to a specific example embodiment of this disclosure, an information handling system may comprise: a cluster comprising a first node and a second node; a first shared disk mapping driver associated with the first node and a second shared disk mapping driver associated with the second node; the first node and the second node in communication with at least one shared storage disk; and the first shared disk mapping driver configured to communicate with the second shared disk mapping driver to assign a common device name to the at least one shared storage disk.

According to another specific example embodiment of this disclosure, a driver of an information handling system for mapping shared disks in a cluster may comprise: an arbitration module configured to determine a master driver among two or more drivers; and a device name assignment module configured to assign a common device name to an associated shared storage disk to be used by a two or more nodes sharing the shared storage disk.

According to yet another specific example embodiment of this disclosure, a method for mapping shared storage devices in a cluster may comprise the steps of: providing a shared disk mapping driver with each of two or more nodes in a cluster; determining a master shared disk mapping driver and one or more non-master shared disk mapping drivers; assigning with the master driver a common device name to at least one shared storage disk; communicating the common device name to the non-master shared disk mapping drivers; and assigning with the non-master shared disk mapping drivers the common device name for identifying the associated shared storage disk.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of an information handling system having electronic components mounted on at least one printed circuit board (PCB) (motherboard not shown) and communicating data and control signals therebetween over signal buses;

FIG. 2 is a schematic flow diagram for a method of mapping disk drives in a shared disk cluster, according to a specific example embodiment of the present disclosure; and

FIG. 3 is a schematic functional block diagram of a shared disk mapping driver, according to a specific example embodiment of the present disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of specific example embodiments are schematically illustrated. Like elements in the drawings will be represented by like numbers, and similar elements will be represented by like numbers with a different lower case letter suffix.

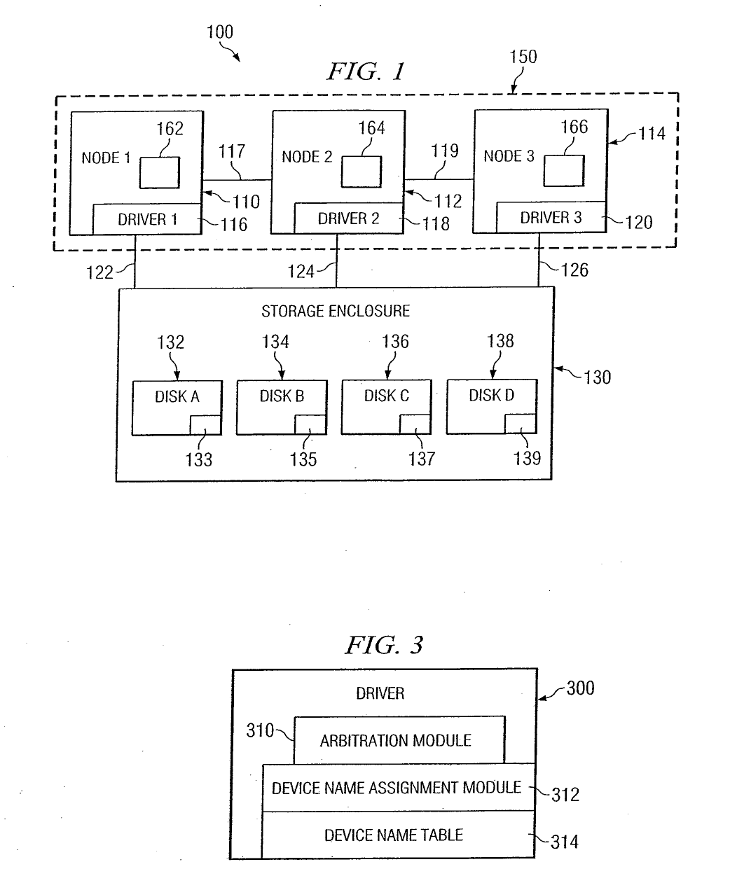

Referring to FIG. 1, depicted is a schematic block diagram of an information handling system having electronic components mounted on at least one printed circuit board (PCB) (motherboard not shown) and communicating data and control signals therebetween over signal. In one example embodiment, the information handling system is a computer system. The information handling system, generally referenced by the numeral 100, may generally include a first node 110, a second node 112 and a third node 114. The first node 110, the second node 112 and the third node 114 may be part of a cluster 150 generally indicated within the dashed lines. In a particular specific example embodiment, cluster 150 may comprise an Oracle real application cluster (RAC).

The first node 110 may include first shared disk mapping driver 116 and device name table 162. The second node 112 may include second shared disk mapping driver 118 and second device name table 164. The third node 114 may include third shared disk mapping driver 120 and associated device name table 166. As described herein, shared disk mapping drivers 116, 118 and 120 may be generally referred to as drivers herein and may comprise either hardware and/or software, including executable instruction and controlling logic stored in a suitable storage media, for carrying out the functions described herein. The first node 110 is in communication with the second node 112 via connection 117. The second node 112 is in communication with the third node 114 via connection 119 such that all three nodes 110, 112 and 114 may communicate with one another. In alternate specific example embodiments, nodes 110, 112 and 114 may be interconnected by a network, a Bus or any other suitable connection(s).

The first node 110, the second node 112 and the third node 114 may be in communication with storage enclosure 130. Storage enclosure 130 may include a plurality of disks, e.g., disk A 132, disk B 134, disk C 136 and disk D 138. Disks 132, 134, 136 and 138 may represent any suitable storage media that may be shared by the nodes 110, 112 and 114 of cluster 150. The disks 132, 134, 136 and 138 may each include designated reserved spaces 133, 135, 137 and 139, respectively, which may be designated for entering data for verification between the associated nodes 110, 112 and 114. Reserved spaces 133, 135, 137 and 139 may also be referred to as “offsets” herein.

The RAC cluster 150 may include three nodes, 110, 112 and 114. It is contemplated and within the scope of this disclosure that cluster 150 may comprise more or fewer nodes which may all be interconnected. Also, cluster 150 is shown in communication with a single storage enclosure 130. In alternate specific example embodiments, cluster 150 and the nodes thereof may be in communication with multiple storage enclosures. According to the present specific example embodiment storage enclosure 130 includes four storage disks 132, 134, 136 and 138. In alternate specific example embodiments, storage enclosure 130 may include more or fewer storage disks.

Driver 116 may preferably be configured to perform a number of different functions. For instance, drivers 116, 118 and 120 may be configured to determine a master shared disk mapping driver and one or more non-master shared disk mapping drivers. Non-master shared disk mapping drivers may be referred to as slave mapping drivers or “listener” drivers. A master driver may assign a common name or handle to the shared storage disks and communicate the common device names to the non-master drivers. The non-master drivers are then configured to adopt the common device name within an associated device name table or shared disk table. Drivers 116, 118 and 120 may arbitrate to determine which driver will be the master driver. In one embodiment, the master driver status may be given to the driver associated with the first activated node. In alternate embodiments, any other suitable method may be used to arbitrate which of the drivers is to be the master driver within the cluster. For instance, if first node 110 were activated first, first driver 116 would be deemed the master driver and drivers 118 and 120 would be non-master drivers.

In order to verify that the shared disks are appropriately identified between nodes 110, 112 and 114, a master driver such as, for instance, driver 116 may be configured to write a test message to a reserved space on a shared storage disk (such as reserved space 133 on shared disk 132). The non-master driver (such as non-master drivers 118 and 120 in this example embodiment) may then validate the identity of a shared disk with the non-master shared disk mapping driver by reading the data within the reserved space.

The proposed system utilizes drivers 116, 118 and 120 to communicate between nodes 110, 112 and 114 within cluster 150 and to perform device mapping for shared disks 132, 134, 136 and 138. Nodes 110, 112 and 114 may preferably listen on a port of an IP address for queries from a master node within the cluster 150. The master node may preferably login to the listener's port and begin an exchange of information. The master node may preferably write to one or more shared disks 132, 134, 136 and 138 at an offset (such as one of reserved spaces 133, 135, 137 and 139) in encrypted signature or other specified test message that will allow the listener drivers to read and validate the encrypted signature information. The listener drivers may then read the shared disks at the same reserved space, decrypt the information and compare it to the signature or the known test message. If there is not a read-write match, the listener reports to the master that there is no match, and in case there is a match, the listener preferably communicates the device ID string, such as “\dev\sdb1” to the master. The master may then check the device ID string for the device it had written to. If the device ID string reported by the listener matches the master, the given device mapping (in this case, \dev\stb1) is valid for both the master and the listener to be used for the shared disk (disk 132) in question. In this case, both master and listener may create an auxiliary file, handle or other identifier such as “SHAREDISK1” for the shared disk 132. The master may then traverse through the list of shared devices within device name table 162 and communicate with all listener nodes in the manner explained above. In this way, nodes 112, 114 and 116 within cluster 150 will have the same handles for the shared storage disks, providing a consistent view of the disks within storage enclosure 130.

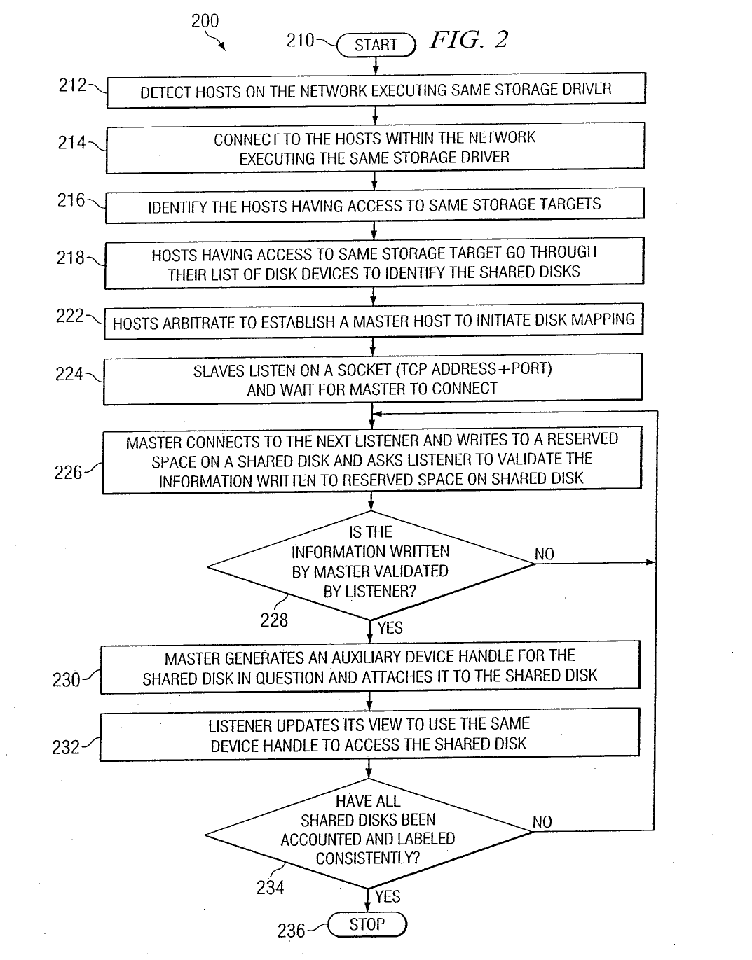

Referring now to FIG. 2, depicted is a flow diagram of a method for mapping disk drives in a shared disk cluster, according to a specific example embodiment of the present disclosure. The method, generally indicated by the numeral 200, starts at step 210. In step 212, all hosts or nodes on a network are detected that execute the same specified storage driver (or shared disk mapping driver). In step 214, connection is made to all hosts within the network that are executing the same storage driver. In step 216, all hosts having access to the same storage targets are identified. In step 218, identification is made of disks that are shared by hosts having the same storage target. In step 222, the nodes or drivers may preferably arbitrate to establish a master host or master driver to initiate disk mapping. In step 224, the slaves (non-masters) may listen on a socket (e.g., a TCP address plus port) and wait for the master to connect. In step 226, the master connects to the next listener (listening device), writes to a reserved space on a shared disk and instructs the listening device to validate the information written to the reserved space on the shared disk.

In step 228, a determination is made whether the information written by the master is validated by the listener. If the information is not validated then step 226 is performed again on the next listener. If the information is validated, then in step 230 the master driver may generate an auxiliary device handle for the shared disk in question and attach it to that shared disk. Then in step 232, the listener updates its view to use the same device handle (name) to access the shared disk. In step 234, a determination is made whether all the shared disks have been accounted and labeled consistently. If all of the disks have not been accounted for then step 226 is performed again on the next listener. If all of the disks have been accounted for, then in step 236 mapping of the disk drives stops.

Referring now to FIG. 3, depicted is a schematic functional block diagram of a shared disk mapping driver, according to a specific example embodiment of the present disclosure. The driver is generally represented by the numeral 300. Driver 300 includes arbitration module 310, device name assignment module 312 and device name table 314. Arbitration module 310 may be configured to arbitrate between multiple drivers on multiple nodes to determine which driver and node will serve as the master and which drivers and nodes will be labeled as non-master or slave devices or listener devices. Device name assignment module 312 may be configured to compare device names and also to generate device names to be used amongst the various drivers. The device name table 314 may be used to list the shared storage devices attached or associated with the different nodes. In alternate specific example embodiments, device name table 314 may be stored on a separate memory component. Modules 310 and 312 may comprise hardware and/or software including control logic and executable instructions stored on a tangible medium for carrying out the functions described herein.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. An information handling system comprising:
a cluster comprising a first node and a second node;
a first shared disk mapping driver associated with the first node and a second shared disk mapping driver associated with the second node;
the first node and the second node in communication with at least one shared storage disk; and
the first shared disk mapping driver configured to communicate with the second shared disk mapping driver to assign a common device name to the at least one shared storage disk.

2. The information handling system according to claim 1, wherein the cluster comprises a Real Application Cluster (RAC).

3. The information handling system according to claim 1, wherein the cluster comprises a plurality of nodes and each node comprises an associated shared disk mapping driver.

4. The information handling system according to claim 1, wherein each node comprises a device name table.

5. The information handling system according to claim 1, wherein the first shared disk mapping driver is configured to communicate with the second shared disk mapping driver to determine a master driver for assigning the common device name.

6. The information handling system according to claim 1, wherein the master driver comprises the driver associated with the first activated node.

7. The information handling system according to claim 1, wherein the first shared disk mapping driver is configured to write a test data message to a reserved space on the shared disk and the second shared disk is configured to validate test data to verify the identity of the shared disk.

8. The information handling system according to claim 1, wherein the at least, one storage disk is housed in a storage enclosure.

9. The information handling system according to Clam 1, further comprising a plurality of shared storage disks in communication with the first node and the second node.

10. The information handling system according to claim 1, wherein the first shared disk mapping driver is configured to detect the second shared disk mapping driver.

11. A driver of an information handling system for mapping shared disks in a cluster comprising:
an arbitration module configured to determine a master driver among two or more drivers; and
a device name assignment module configured to assign a common device name to an associated shared storage disk to be used by a two or more nodes sharing the shared storage disk.

12. The driver according to claim 11, further comprising the device name assignment module configured to assign a common device name to each of a plurality of associated shared storage disks.

13. The driver according to claim 11, further comprising an associated shared disk table configured to list the assigned names of the shared storage disks.

14. The driver according to claim 11, wherein the arbitration module is configured to communicate with a second shared disk mapping driver for determining the master driver for assigning the common device name.

15. The driver according to claim 11, wherein the master driver comprises the first activated driver.

16. The driver according to claim 11, wherein the device name assignment module is configured to write a test message to a reserved space on a shared disk for validation by a shared disk mapping driver associated with a separate node.

17. A method for mapping shared storage devices in a cluster, said method comprising the steps of:
providing a shared disk mapping driver with each of two or more nodes in a cluster;
determining a master shared disk mapping driver and one or more non-master shared disk mapping drivers;
assigning with the master driver a common device name to at least one shared storage disk;
communicating the common device name to the non-master shared disk mapping drivers; and
assigning with the non-master shared disk mapping drivers the common device name for identifying the associated shared storage disk.

18. The method according to claim 17, wherein the two or more nodes comprise a Real Application Cluster (RAC).

19. The method according to claim 17, further comprising the steps of:
writing a test message to a reserved space or a shared disk with the master shared disk mapping driver; and
validating the identity of the shared disk with the non-master shared disk mapping driver by validating the test message stored on the shared disk.

20. The method according to claim 17, further comprising the step of assigning the master shared disk mapping driver status to the driver associated with the first activated node.
